(19) United States
(12) Patent Application Publication
(10) Pub. No.: US 2025/0133553 A1
(43) Pub. Date: Apr. 24, 2025

(54) WIRELESS COMMUNICATION METHOD FOR POSITIONING, DEVICE, AND CHIP

(71) Applicant: GUANGDONG OPPO MOBILE TELECOMMUNICATIONS CORP., LTD., Dongguan (CN)

(72) Inventor: Zuomin WU, Dongguan (CN)

(21) Appl. No.: 19/006,451

(22) Filed: Dec. 31, 2024

Related U.S. Application Data
(63) Continuation of application No. PCT/CN2022/111936, filed on Aug. 11, 2022.

(51) Int. Cl. H04W 72/0453; H04L 5/00; H04W 64/00

(52) U.S. Cl. CPC H04W 72/0453; H04L 5/005; H04W 64/00

(57) ABSTRACT

A wireless communication method for positioning, applicable to a terminal device, is provided. The method includes transmitting an uplink positioning signal on an uplink positioning signal resource based on a timing advance (TA) value. A wireless communication method for positioning, applicable to a network device, is provided. The method includes determining and/or reporting first measurement information based on an uplink positioning signal received on an uplink positioning signal resource.

### CROSS-REFERENCE TO RELATED APPLICATION

This application is a continuation application of international application No. PCT/CN2022/111936, filed on Aug. 11, 2022, the entire content of which is incorporated herein by reference in its entirety.

### TECHNICAL FIELD

The present disclosure relates to the field of positioning, and in particular, relates to a wireless communication method for positioning, a device, and a chip.

### RELATED ART

In positioning technologies related to terrestrial network (TN) systems, ideal assumptions about timing errors can be made to ensure the performance of positioning methods.

### SUMMARY

Embodiments of the present disclosure provide a wireless communication method and apparatus for positioning, a device, and a chip.

According to some embodiments of the present disclosure, a wireless communication method for positioning is provided. The method is applicable to a terminal device and includes:
transmitting an uplink positioning signal on an uplink positioning signal resource based on a TA value.

According to some embodiments of the present disclosure, a wireless communication method for positioning is provided. The method is applicable to a network device and includes:
determining and/or reporting first measurement information based on an uplink positioning signal received on an uplink positioning signal resource.

According to some embodiments of the present disclosure, a terminal is provided. The terminal includes: a processor; a transceiver connected to the processor; and a memory configured to store one or more instructions executable by the processor; wherein the processor, when loading and executing the one or more executable instructions, is caused to perform the wireless communication method for positioning according to the above embodiments.

According to some embodiments of the present disclosure, a network device is provided. The network device includes: a processor; a transceiver connected to the processor; and a memory configured to store one or more instructions executable by the processor; wherein the processor, when loading and executing the one or more executable instructions, is caused to perform the wireless communication method for positioning according to the above embodiments.

According to some embodiments of the present disclosure, a chip is provided. The chip includes at least one programmable logic circuit and/or at least one program instruction, and a communication device equipped with the chip, when running, is caused to perform the wireless communication method for positioning according to the above embodiments.

### BRIEF DESCRIPTION OF DRAWINGS

For clearer descriptions of the technical solutions according to the embodiments of the present disclosure, the following briefly introduces the accompanying drawings required for describing the embodiments. Apparently, the accompanying drawings in the following description show merely some examples of the present disclosure, and those of ordinary skill in the art may still derive other drawings from these accompanying drawings without creative efforts.

FIG. 1 is a schematic diagram of an architecture of a communication system in the related art;

FIG. 2 is a schematic diagram of an architecture of a communication system in the related art;

FIG. 3 is a schematic diagram of a communication system according to some embodiments of the present disclosure;

FIG. 4 is a schematic diagram of an uplink positioning scenario according to some embodiments of the present disclosure;

FIG. 5 is a schematic diagram of the principle of an uplink positioning scenario according to some embodiments of the present disclosure;

FIG. 6 is a schematic diagram of a positioning scenario according to some embodiments of the present disclosure;

FIG. 7 is a schematic diagram of a positioning scenario according to some embodiments of the present disclosure;

FIG. 8 is a schematic diagram of a positioning system according to some embodiments of the present disclosure;

FIG. 9 is a schematic flowchart of a wireless communication method for positioning according to some embodiments of the present disclosure;

FIG. 10 is a flowchart of a wireless communication method for positioning according to some embodiments of the present disclosure;

FIG. 11 is a flowchart of a wireless communication method for positioning according to some embodiments of the present disclosure;

FIG. 12 is a flowchart of a wireless communication method for positioning according to some embodiments of the present disclosure;

FIG. 13 is a flowchart of a wireless communication method for positioning according to some embodiments of the present disclosure;

FIG. 14 is a structural block diagram of a wireless communication apparatus for positioning according to some embodiments of the present disclosure;

FIG. 15 is a structural block diagram of a wireless communication apparatus for positioning according to some embodiments of the present disclosure; and

FIG. 16 is a schematic structural diagram of a wireless communication device for positioning according to some embodiments of the present disclosure.

### DETAILED DESCRIPTION

For clearer descriptions of the objectives, technical solutions and advantages of the present disclosure, implementations of the present disclosure are further described in detail in combination with the accompanying drawings. Exemplary embodiments are described in detail herein, and examples thereof are represented in the accompanying drawings. In the following descriptions related to the accompanying drawings, unless otherwise indicated, the same numerals in different accompanying drawings represent same or similar elements. The implementations described in the following exemplary embodiments do not represent all implementations consistent with the present disclosure. On the contrary, the implementations are merely examples of apparatuses and methods that are described in detail in the appended claims and consistent with some aspects of the present disclosure.

The term “a plurality of” in this specification means two or more. The term “and/or” describes associations between associated objects, and it indicates three types of relationships. For example, the phrase “A and/or B” means (A), (B) or (A and B). The character “/” usually indicates an “or” relationship between associated objects.

The terms used in the present disclosure are merely to describe the specific embodiments, instead of limiting the present disclosure. The singular forms such as “a,” “an,” “the” in the present disclosure and the appended claims are also intended to include the plural forms, unless otherwise clearly stated in the context.

It should be understood that although terms such as “first,” “second,” and “third” may be used in the present disclosure to describe various types of information, the information is not limited to these terms. These terms are only used to distinguish information of a same type from each other. For example, without departing from the scope of the present disclosure, “first” information may be referred to as “second” information, and similarly, “second” information may be referred to as “first” information. Depending on the context, “if” used herein can be interpreted as “when,” “while,” or “in response to determining.”

In non-terrestrial network (NTN) systems, due to characteristics such as large signal transmission delays and satellite movement, ideal assumptions about timing errors in positioning technologies related to the TN system are inapplicable in the NTN system. Currently, there is no specific solution for enhancing positioning in the NTN system.

First, a related technology in the present disclosure is introduced.

### Network Scenario:

Communication system scenarios involve the TN and the NTN. The NTN generally employs satellite communications to provide communication services to terrestrial users. At present, the NTN system includes the new radio (NR)-NTN system and the Internet of things (IoT)-NTN system.

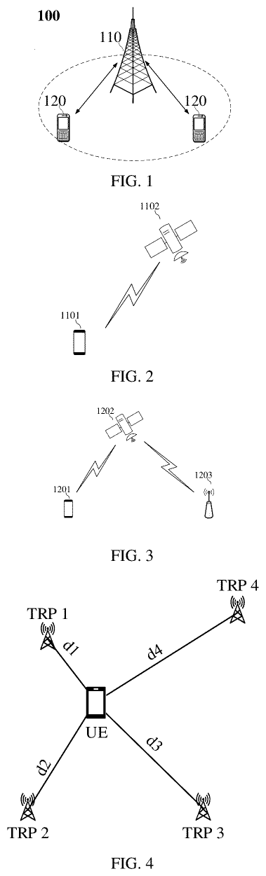

For example, FIG. 1 is a schematic diagram of an architecture of a communication system in the related art. As shown in FIG. 1, a communication system 100 includes a network device 110. The network device 110 communicates with a terminal device 120 (which is alternatively referred to as a communication terminal device or a terminal). The network device 110 may provide communication coverage for a specific geographical area and communicate with terminal devices within the coverage.

FIG. 1 exemplarily illustrates a network device and two terminal devices. In some cases, the communication system 100 includes a plurality of network devices and other quantities of terminal devices within the coverage of each of plurality of the network devices, which is not limited in the present disclosure.

For example, FIG. 2 is a schematic diagram of an architecture of another communication system in the related art. As shown in FIG. 2, the communication system includes a terminal device 1101 and a satellite 1102. Wireless communication may be conducted between the terminal device 1101 and the satellite 1102. The network formed between the terminal device 1101 and the satellite 1102 may also be referred to as an NTN. In the architecture of the communication system shown in FIG. 2, the satellite 1102 has a function of a base station, and the terminal device 1101 is capable of directly communicating with the satellite 1102. In the architecture of the communication system, the satellite 1102 is referred to as a network device. In some embodiments, the communication system includes a plurality of network devices (that is, satellites 1102) and other quantities of terminal devices within the coverage of each of the plurality of network devices 1102, which is not limited in the present disclosure.

For example, FIG. 3 is a schematic diagram of an architecture of a communication system according to the embodiments of the present disclosure. As shown in FIG. 3, the communication system includes a terminal device 1201, a satellite 1202, and a base station 1203. Wireless communication may be conducted between the terminal device 1201 and the satellite 1202, and between the satellite 1202 and the base station 1203. The network formed between the terminal device 1201, the satellite 1202, and the base station 1203 is also referred to as an NTN. In the architecture of the communication system shown in FIG. 3, the satellite 1202 does not have a function of the base station, and the communication between the terminal device 1201 and the base station 1203 needs to be relayed via the satellite 1202. In the architecture of the communication system, the base station 1203 is referred to as a network device. In some embodiments, the communication system includes a plurality of network devices (that is, base stations 1203) and other quantities of terminal devices within the coverage of each of the plurality of network device 1203, which is not limited in the present disclosure.

Synchronization in the NR-NTN and IoT-NTN systems:

In the NTN system, the network device needs to transmit synchronization auxiliary information to the terminal device, and the synchronization auxiliary information assists the terminal device to complete time-domain and/or frequency-domain synchronization. The synchronization auxiliary information indicates at least one of: serving satellite ephemeris information, a public TA value parameter, reference instant indication information (epoch time, for determining an instant t0), or a target timer duration.

The terminal device completes the corresponding time-domain and/or frequency-domain synchronization based on the synchronization auxiliary information and a capability of a global navigation satellite system (GNSS) of the terminal device. Based on the capability of the GNSS of the terminal device, the terminal device acquires at least one of: a position of the terminal device, a time reference, or a frequency reference of the terminal device. Moreover, based on the above information and the information acquired based on the synchronization auxiliary information, the terminal device acquires timing and/or frequency offset, and applies TA compensation and/or frequency offset adjustment in an idle state, an inactive state, or a connected state.

Specifically, in the case that the terminal device transmits an uplink channel or an uplink signal, the TA value is:

$${T}_{TA} = ( {N}_{TA} + {N}_{TA , offset} + {N}_{TA , adj}^{common} + {N}_{TA , adj}^{UE} ) {T}_{c}$$

wherein N_{TA} represents the TA value indicated by the network device, for example, a TA value issued over a TA command. In the case that the uplink channel or uplink signal includes a physical random access channel (PRACH) or MsgA (message A in two-step random access procedure) transmission, N_{TA} takes the value of 0.

N_{TA}, offset is equal to the value in the related art, for example, the value is determined based on the coexistence of the long-term evolution (LTE) or NR with the fabric band.

N_{TA,adj}^{common} is acquired based on a public TA value parameter (for example, at least one of VTA, adj the public timing value, a public timing value offset, or a change rate of the public timing value offset) of a higher-layer configuration. In the case that the public TA value parameter is not configured, N_{TA,adj}^{common} takes the value of 0. In some cases, N_{TA,adj}^{common} is also referred to as a feeder link TA value.

N_{TA,adj}^{UE} is calculated based on the position of the terminal device and the serving satellite ephemeris information of a higher-layer configuration. In the case that the serving satellite ephemeris information is not configured, N_{TA,adj}^{UE} takes the value of 0. In some cases, N_{TA,adj}^{UE} is also referred to as a serving link TA value.

T_{c} indicates a sampling time interval unit, and T_{c}=1/(480*1000*4096).

Because the satellite is moving, the synchronization auxiliary information changes with the change of time. For example, the serving satellite ephemeris information changes with the change of time. The public TA value parameters include: the public timing value, the public timing value offset (for example, the first-order derivative of the public timing value), a change rate of the public timing value offset (for example, the second-order derivative of the public timing value), and the like. The terminal device determines the serving satellite ephemeris information at different instants and the public TA values at different instants based on the synchronization auxiliary information to acquire the TA values at different instants.

That is, in the NTN system, the difference between the TA values corresponding to different instants is great.

### Positioning Technology in the NR System:

In the NR system, the supported positioning methods include a downlink time difference of arrival (DL-TDOA) positioning method, the uplink time difference of arrival (UL-TDOA) positioning method, and the multi-round trip time (multi-RTT) positioning method, and the like. The present disclosure is applicable to methods including, but not limited to, the above methods, for example, the present disclosure is applicable to the UL-TDOA positioning method.

The transmission time of the signal is directly related to the transmission distance, such that the deviation between the transmission time of the signals transmitted by the terminal device arriving at a plurality of network nodes also reflects the distance difference between the terminal device and the plurality of network nodes. The network nodes are considered as TRPs, network devices, transmission points (TPs), serving satellites, or the like. The basic principle of the UL-TDOA positioning method is to estimate the position of the terminal device based on the deviation in transmission time of signals transmitted by the terminal device arriving at a plurality of network nodes and known positions of the network nodes. The UL-TDOA positioning method is based on one-way transmission of measurement signals between the terminal device and the network nodes, that is, the terminal device transmits signals and the network nodes perform measurement. The signals transmitted by the terminal device to different network nodes are the same uplink reference signal or different uplink reference signals, which depends on the network configuration.

The following describes the UL-TDOA positioning method. As shown in FIG. 4, there are M=4 network nodes. For example, the network node is a TRP, and the four network nodes are denoted as TRP 1, TRP 2, TRP 3, and TRP 4. Three-dimensional coordinates and a receive timing error corresponding to the network node TRP i (i=1, 2, . . . , M) are recorded as (xᵢ, yᵢ, zᵢ) and τᵢ^{Rx} respectively. Three-dimensional coordinates corresponding to the terminal device and a transmit timing error for transmitting the uplink positioning signal to the network node TRP i are recorded as (x_{UE}, y_{UE}, z_{UE}) and TUE, respectively. In the case that the distance between the network node TRP i and the terminal device is denoted as dᵢ, the calculation equation of TOA is shown in the following equation (1):

$${TOA}_{i} = \frac{\sqrt[2]{{( {x}_{i} - {x}_{UE} )}^{2} + {( {y}_{i} - {y}_{UE} )}^{2} + {( {z}_{i} - {z}_{UE} )}^{2}}}{c} + {τ}_{i}^{Rx} - {τ}_{UE , i}^{Tx} + {n}_{i} , \\ i = 1 , 2 , ... , M \qquad ( 1 )$$

c represents the speed of light, and nᵢ represents the error.

In the actual scenario, by adopting high-precision devices and proper deployment, the network nodes generally achieve better synchronization precision. Even if a small synchronization error is present, the error generally does not significantly affect the positioning precision. Therefore, in general, it is assumed that τᵢ^{Rx}=0. Within a time period, the timing error of the same terminal device changes very little, and therefore it is considered that in the above equation (1), τ_{UE,1}^{Tx}=τ_{UE,2}^{Tx}=τ_{UE,M}^{Tx}. The basic principle of the TDOA positioning method is cancelling the item related to τ_{UE,i}^{Tx} by taking the difference between two estimated TOAs. Assuming that TRP 1 is used as a reference (in this case, TRP 1 is referred to as a reference TRP) to calculate TOA differences corresponding to different TRPs, then M−1 constraint equations are acquired, and a constraint equation set shown in the following equation (2) is formed:

$${TDOA}_{i , 1} = {TOA}_{i} - {TOA}_{1} = \frac{\sqrt[2]{{( {x}_{i} - {x}_{UE} )}^{2} + {( {y}_{i} - {y}_{UE} )}^{2} + {( {z}_{i} - {z}_{UE} )}^{2}}}{c} + {n}_{i} - \frac{\sqrt[2]{{( {x}_{1} - {x}_{UE} )}^{2} + {( {y}_{1} - {y}_{UE} )}^{2} + {( {z}_{1} - {z}_{UE} )}^{2}}}{c} - {n}_{1} \qquad ( 2 )$$

c represents the speed of light, and nᵢ and n₁ represent the errors.

Equivalently, in the case that an error is present between the terminal device timing and the network device timing, it can be seen from the above equation (2) that this error is also eliminated. In order to acquire reliable position information containing K (for example, K is 3) unknown variables, at least M≥K+1 (for example, M is 4) network nodes are needed.

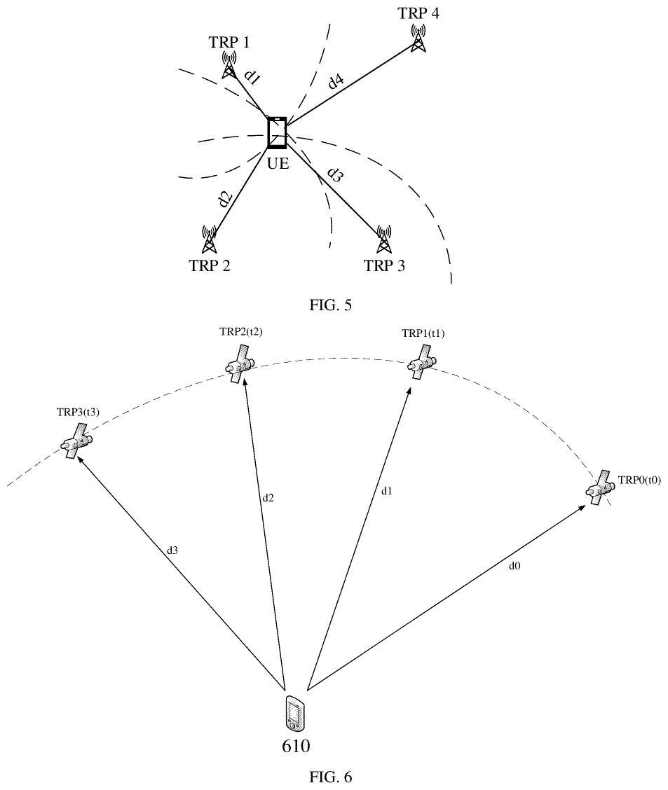

Each equation in the constraint equation set shown in the above equation (2) is regarded as a hyperbola focusing on TRP i and TRP 1. Therefore, the physical meaning of the TDOA positioning method may be understood with reference to FIG. 5: corresponding hyperbolas are drawn with each network node pair (TRP I, TRP 1) as the foci, and the positions at which these hyperbolas intersect represent the positions, of the terminal device, estimated by using the TDOA positioning method. Due to estimation errors nᵢ and other factors, these hyperbolas usually do not intersect at a single point perfectly, instead, these hyperbolas intersect to form a smaller range.

In the UL-TDOA positioning method, the network device (such as the base station) configures uplink sounding reference signal (SRS) resources, such as positioning SRS resources or multiple-input and multiple-output (MIMO) SRS resources, for the terminal device through radio resource control (RRC) signaling. The network node performs measurement based on the uplink SRS signal transmitted by the terminal device, and the corresponding measurement object is referred to as the uplink relative time of arrival (UL RTOA) in related NR technologies.

The behavior of the terminal device is primarily transmitting SRS signals based on the configuration of the network device. The corresponding measurement is completed by the network node, and the position estimation of the terminal device is completed by a location management function (LMF). Therefore, the implementation of the terminal device is relatively simple. In the case that the terminal device transmits the SRS, a TA value of a serving cell is used.

The terminal device determines a downlink path loss based on a synchronization signal block (SSB) of the serving cell, an SSB of a neighboring cell, or a positioning reference signal (PRS) configured by the network device, and then determine transmission power of the SRS. In the case that the network device configures the SSB of the neighboring cell, a cell identity (ID) and an SSB index of the neighboring cell are configured. In addition, the terminal device determines spatial filter information transmitted over the SRS (or beam information transmitted over the SRS) based on the spatial filter information of the serving cell (or beam information of the serving cell, such as the SSB index, or the channel state information-reference signal (CSI-RS) index, or the SRS resource index associated with SRS transmission) configured by the network device and the SSB or PRS of the neighboring cell.

UL RTOA is defined as a start position of a subframe i containing the SRS received by a reception point (RP) relative to the RTOA reference time. The RTOA reference time is defined as T₀+t_{SRS}, T₀ represents a nominal start time of SFN 0 provided at an initialization time of the system frame number (SFN), t_{SRS}=(10n_{f}+n_{sf})×10⁻³, and n_{f} and n_{sf} are respectively a system frame number and a subframe number of the subframe containing the SRS.

The network node uses a plurality of SRS resources to determine the start position of the subframe i, containing the SRS, and received by the RP.

In the UL-TDOA positioning method, the network node TRP not only measures and reports the UL RTOA, but also optionally reports SRS-reference signal receiving power (RSRP) acquired based on SRS measurement, to help the LMF improve the position estimation precision.

The performance of the above positioning method is affected by the timing errors in the terminal device and the network nodes. In positioning technologies related to the TN system (also considered as the TN scenario), the impact of timing errors on positioning precision is reduced or eliminated by making some ideal assumptions about the timing errors. However, in the NTN system (also considered as the NTN scenario), because the characteristics such as large signal transmission delays and satellite movement, the ideal assumptions about timing errors in positioning technologies related to the TN system are inapplicable in the NTN system. Currently, there is no specific solution for enhancing positioning technologies in the NTN system.

The present disclosure provides a wireless communication method for positioning, and further provides a corresponding apparatus, device, system, and storage medium, all of which are suitable for the NTN system. Descriptions are provided below with reference to exemplary embodiments.

It should be understood that in some embodiments of the present disclosure, a cell and a carrier are equivalent. For example, a “downlink cell” may be replaced by a “downlink carrier,” an “uplink cell” may be replaced by an “uplink carrier,” and the like.

In some embodiments of the present disclosure, “configure” may be understood as being configured by a network device or an LMF.

In some embodiments of the present disclosure, “configure” may be understood as direct configuration or indirect configuration.

In the NTN system, in order to reuse the positioning methods in related technologies to estimate the position of the terminal device, positions of a serving satellite at different instants are equivalent to different TRPs, which are referred to as virtual TRPs in some embodiments of the present disclosure, such that the position of the terminal device is estimated based on the relative distances between the positions of the serving satellite at different instants (also considered as positions of the virtual TRPs) and the terminal device. Specifically, a serving satellite position at an instant ti is regarded as TRP i, and a distance between TRP i and the terminal device is di, wherein i=0, 1, 2, . . . , M−1. M is the number of TRPs and is also considered as the number of instants corresponding to the serving satellite positions.

FIG. 6 is a schematic diagram of a positioning scenario in the NTN scenario according to some exemplary embodiments of the present disclosure. As shown in FIG. 6, a serving satellite position at an instant t0 is regarded as TRP 0, and a distance between TRP 0 and a terminal device 601 is do; a serving satellite position at an instant t1 is regarded as TRP 1, and a distance between TRP 1 and the terminal device 601 is d1; a serving satellite position at an instant t2 is regarded as TRP 2, and a distance between TRP 2 and the terminal device 601 is d2; a serving satellite position at an instant t3 is regarded as TRP 3, and a distance between TRP 3 and the terminal device 601 is d3. Accordingly, positioning methods in related technologies, such as the UL-TDOA positioning method, is also adopted in the NTN scenario.

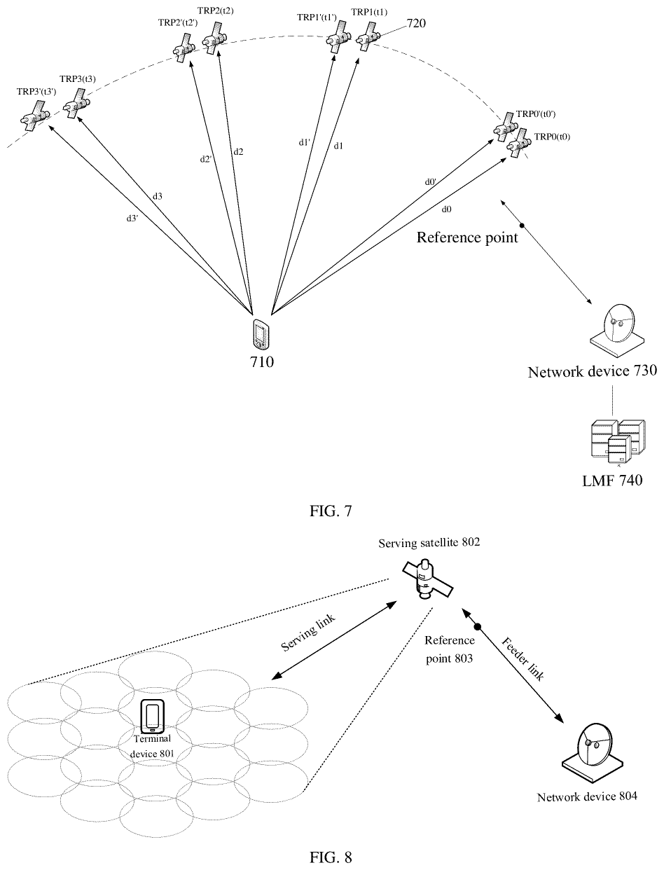

FIG. 7 is a schematic diagram of a positioning system according to some exemplary embodiments of the present disclosure. The positioning system 700 includes a terminal device 710, a serving satellite 720, and a network device 730.

The serving satellite 720 includes at least one virtual TRP and/or at least one virtual TRP group. The virtual TRP group includes at least one virtual TRP, and a number of virtual TRPs in each virtual TRP group is the same or different.

In some embodiments, the virtual TRP is simply referred to as a TRP, and the virtual TRP group is also simply referred to as a TRP group.

In some embodiments, the positioning system 700 further includes a core network or a network slice, such as an LMF 740.

In some embodiments, the positioning system 700 positions the terminal device 710 based on M virtual TRPs implemented by the serving satellite 720.

The M virtual TRPs are in one-to-one correspondence with serving satellite positions at M instants; and/or

the M virtual TRPs are in one-to-one correspondence with M uplink positioning signal resources; and/or

the serving satellite positions at the M instants are in one-to-one correspondence with the M uplink positioning signal resources, wherein M is an integer greater than or equal to 1, and the M instants are different instants in the case that M is an integer greater than 1.

In some embodiments, transmit timing errors of uplink positioning signals corresponding to the M uplink positioning signal resources are within a first error range, and/or receive timing errors of the uplink positioning signals corresponding to the M uplink positioning signal resources are within a second error range; transmit timing errors of uplink positioning signals corresponding to the M virtual TRPs are within a first error range, and/or receive timing errors of the uplink positioning signals corresponding to the M virtual TRPs are within a second error range; or transmit timing errors of uplink positioning signals corresponding to the serving satellite positions at the Minstants are within a first error range, and/or receive timing errors of the uplink positioning signals corresponding to the serving satellite positions at the M instants are within a second error range.

In some embodiments, at least one of the first error range and the second error range is default, configured, or predefined.

In some embodiments, the first error range indicates that the errors in the first error range are small, for example, less than a threshold, or negligible within a specific error range.

In some embodiments, the second error range may mean that the errors in the second error range are sufficiently small, for example, less than a threshold, or negligible within a specific error range.

In some embodiments, the M uplink positioning signal resources are uplink positioning signal resources in a first uplink positioning signal resource group, and the first uplink positioning signal resource group is one of N configured uplink positioning signal resource groups; the M virtual TRPs are virtual TRPs in a first virtual TRP group, and the first virtual TRP group is one of N configured virtual TRP groups; or the serving satellite positions at the M instants are serving satellite positions in a first serving satellite position group, and the first serving satellite position group is one of N configured serving satellite position groups.

N is an integer greater than or equal to 1.

As shown in FIG. 7, the virtual TRPs in the positioning system 700 include: TRP 0 (corresponding to a serving satellite position at an instant t0), TRP 0′ (corresponding to a serving satellite position at an instant t0′), TRP 1 (corresponding to a serving satellite position at an instant t1), TRP 1′ (corresponding to a serving satellite position at an instant t1′), TRP 2 (corresponding to a serving satellite position at an instant t2), TRP 2′ (corresponding to a serving satellite position at an instant t2′), TRP 3 (corresponding to a serving satellite position at an instant t3), and TRP 3′ (corresponding to a serving satellite position at an instant t3′).

Optionally, TRP 0 and TRP 0′ form a virtual TRP group 0, TRP 1 and TRP 1′ form a virtual TRP group 1, TRP 2 and TRP 2′ form a virtual TRP group 2, and TRP 3 and TRP 3′ form a virtual TRP group 3.

The present embodiment is schematically illustrated as an example of the positioning system 700 including four virtual TRP groups, wherein each of the virtual TRP groups includes two virtual TRPs.

The terminal device 710 in the present disclosure is also referred to as user equipment (UE), an access terminal, a user unit, a user station, a mobile station, a distant station, a remote terminal, a mobile device, a user terminal, a terminal, a wireless communication device, a user proxy, a user apparatus, or the like. The terminal device 710 includes, but is not limited to, a handheld device, a wearable device, a vehicle-mounted device, and an IoT device, such as a mobile phone, a tablet computer, an e-book reader, a laptop computer, a desktop computer, a television, a game console, a mobile Internet device (MID), an augmented reality (AR) terminal, a virtual reality (VR) terminal, a mixed reality (MR) terminal, a wearable device, a gamepad, an electronic tag, a controller, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, a wireless terminal in remote medical surgery, a cellular phone, a cordless phone, a Session Initiation Protocol (SIP) phone, a wireless local loop (WLL) station, a personal digital assistant (PDA), a set-top box (STB), or customer premise equipment (CPE).

The serving satellite 720 in the present disclosure has a communication function and is regarded as a TRP or TP.

The network device 730 in the present disclosure has a communication function, and network device 730 includes but not limited to: an evolved Node B (eNB), a radio network controller (RNC), a Node B (NB), a base station controller (BSC), a base transceiver station (BTS), a home base station (such as a home evolved Node B or a home Node B (HNB)), a baseband unit (BBU), an access point (AP) in a wireless fidelity (Wi-Fi) system, a wireless relay node, a wireless backhaul node, a network device, a TP or a TRP, a next generation Node B (gNB) or a transmission point (TRP or TP) in the 5^{th} generation (5G) system, one or one group of antenna panels (including a plurality of antenna panels) of a base station in the 5G system, a network node that constitutes the gNB or transmission point, such as a BBU or a distributed unit (DU), a base stations in the 6G communication system, a radio access network (RAN) device, or a network slice.

The serving satellite 720 and the terminal device 710 communicate with each other via a specific air interface technology.

For example, the serving satellite 720 and the terminal device 710 are involved in an uplink communication scenario and a downlink communication scenario. The uplink communication refers to transmitting signals to the serving satellite 720, and the downlink communication refers to transmitting signals to the terminal device 710.

The network device 730 communicates with the terminal device 710 via a specific air interface technology, such as over the Uu interface.

For example, two communication scenarios are present between the network device 730 and the terminal device 710: an uplink communication scenario and a downlink communication scenario. The uplink communication refers to transmitting signals to the network device 730, and the downlink communication refers to transmitting signals to the terminal device 710.

The serving satellite 720 and the network device 730 communicate with each other via a specific air interface technology.

For example, two communication scenarios are present between the serving satellite 720 and the network device 730: an uplink communication scenario and a downlink communication scenario. The uplink communication refers to transmitting signals to the serving satellite 720, and the downlink communication refers to transmitting signals to the network device 730.

The technical solutions in the embodiments of the present disclosure are applied to various communication systems, such as a global system for mobile communication (GSM), a code division multiple access (CDMA) system, a wideband code-division multiple access (WCDMA) system, a general packet radio service (GPRS) system, a long-term evolution (LTE) system, an LTE frequency-division duplex (FDD) system, an LTE time-division duplex (TDD) system, an advanced LTE (LTE-A) system, a universal mobile telecommunication system (UMTS), a worldwide interoperability for microwave access (WiMAX) communication system, a 5G mobile communication system, an NR system, an evolved system of the NR system, an LTE-based access to unlicensed spectrum (LTE-U) system, an NR-based access to unlicensed spectrum (NR-U) system, a TN system, an NTN system, a wireless local area network (WLAN), a Wi-Fi network, a cellular IoT system, a cellular passive IoT system, an evolved system of the 5G NR system, a beyond fifth generation (B5G) mobile communication system, or a 6G and evolved system. In some embodiments of the present disclosure, NR may also be referred to as the 5G NR system or 5G system. The 5G mobile communication systems include a non-standalone (NSA) network and/or a standalone (SA) network.

The technical solutions in the embodiments of the present disclosure are further applied to machine-type communications (MTC), long-term evolution-machine (LTE-M), device-to-device (D2D) networks, machine-to-machine (M2M) networks, the IoT or other networks. The IoT may include, for example, Internet of vehicles (IoV). The communication means in the IoV system are collectively referred to as vehicle to X (V2X, wherein X stands for everything). For example, V2X includes: vehicle-to-vehicle (V2V) communications, vehicle-to-infrastructure (V2I) communications, vehicle-to-pedestrian (V2P) communications, or vehicle-to-network (V2N) communications.

The positioning system according to the embodiments is applied to, but not limited to at least one of the DL-TDOA positioning method, the UL-TDOA positioning method, or the Multi-RTT positioning method.

In the TN scenario, in the case that the terminal device transmits the SRS, a TA value of a serving cell is used. In the NTN scenario, the TA value of the serving cell of the terminal device includes: a serving link TA value estimated based on the GNSS capability of the terminal device and the serving satellite ephemeris information, and a feeder link TA value determined based on a public TA value parameter. As shown in FIG. 8, a serving link refers to a transmission link between the terminal device 801 and the serving satellite 802, and a feeder link refers to a transmission link between the serving satellite 802 and the network device 804. Both the serving link TA value and the feeder link TA value change with the change of time. A reference point is a reference point on the feeder link. A round trip delay of the link between the serving satellite 802 and the reference point is a public TA value.

Because the serving satellite at different instants are equivalent to different (virtual) TRPs. In the NTN scenario, in the case that the TA value of the serving cell is still used to transmit the SRS, the deviation in transmissions time of SRSs received by the network device from the terminal device at different instants is compensated. This results in the unavailability of the UL-TDOA positioning method.

Therefore, the present disclosure provides the following UL-TDOA positioning method suitable for the NTN scenario.

FIG. 9 is a schematic flowchart of a wireless communication method for positioning according to some exemplary embodiments of the present disclosure. For example, the method is applicable to a terminal device, and the method includes at least some of the following processes.

In 920, an uplink positioning signal is transmitted on an uplink positioning signal resource based on a TA value.

The terminal device is a terminal device in an NTN system or an evolved system of the NTN system, such as the terminal device 710 shown in FIG. 7.

The uplink positioning signal is transmitted by the terminal device to a serving satellite, which may be the serving satellite 720 shown in FIG. 7.

In some embodiments, transmitting the uplink positioning signal on the uplink positioning signal resource based on the TA value is also understood as transmitting the uplink positioning signal by using the uplink positioning signal resource based on the TA value.

In some embodiments, the uplink positioning signal is transmitted on at least one of M uplink positioning signal resources based on a first TA value, wherein M is an integer greater than or equal to 1.

In some embodiments, the first TA value does not include a serving link TA value, or the first TA value is not determined based on the serving link TA value.

In some embodiments, the first TA value includes a feeder link TA value, or the first TA value is determined based on the feeder link TA value.

In some embodiments, the first TA value includes a public serving link TA value, or the first TA value is determined based on the public serving link TA value. The public serving link TA value satisfies at least one of:
the public serving link TA value being configured;
the public serving link TA value being predefined, for example, predefined in a communication protocol;
the public serving link TA value being a serving link TA value of the terminal device at a first instant;
the public serving link TA value being a serving link TA value corresponding to a first reference position; or
the public serving link TA value being a serving link TA value corresponding to the first reference position and the first instant.

The first reference position is a predefined position or a configured position. For example, the first reference position is the center of a cell.

In some embodiments, the first TA value corresponds to the first instant. The first instant satisfies at least one of:
the first instant being configured;
the first instant corresponding to a first uplink positioning signal resource in the M uplink positioning signal resources; or
the first instant corresponding to a transmit instant of the first uplink positioning signal resource in the M uplink positioning signal resources.

In some embodiments, the first uplink positioning signal resource in the M uplink positioning signal resources is predefined or configured.

In some embodiments, a first uplink positioning signal is transmitted on the first uplink positioning signal resource in the M uplink positioning signal resources based on the first TA value, and the first instant corresponds to the first uplink positioning signal resource.

In some embodiments, M uplink positioning signals are transmitted on the M uplink positioning signal resources based on the first TA value.

In some embodiments, in the case that the uplink positioning signal is transmitted on an uplink positioning signal resource k in the M uplink positioning signal resources, the first TA value includes a feeder link TA value corresponding to an instant k.

The instant k corresponds to a transmit instant of the uplink positioning signal resource k.

In some embodiments, the M uplink positioning signal resources are determined based on first configuration information.

In some embodiments, the terminal device receives the first configuration information.

In some embodiments, the M uplink positioning signal resources are uplink positioning signal resources in a first uplink positioning signal resource group, and the first uplink positioning signal resource group is one of N configured uplink positioning signal resource groups, wherein N is an integer greater than or equal to 1.

In some embodiments, the N uplink positioning signal resource groups are determined based on second configuration information.

In some embodiments, the terminal device receives the second configuration information.

In some embodiments, the terminal device receives the first configuration information and/or the second configuration information.

In some embodiments, the uplink positioning signal resources in the first uplink positioning signal resource group satisfy at least one of:
Transmit timing errors of uplink positioning signals corresponding to the uplink positioning signal resources in the first uplink positioning signal resource group being within a first error range; or
receive timing errors of the uplink positioning signals corresponding to the uplink positioning signal resource in the first uplink positioning signal resource group being within a second error range.

In some embodiments, uplink positioning signal resources in each of the N uplink positioning signal resource groups satisfy at least one of:
transmit timing errors of uplink positioning signals corresponding to the uplink positioning signal resources in each of the N uplink positioning signal resource groups being within a third error range; or
receive timing errors of the uplink positioning signals corresponding to the uplink positioning signal resources in each of the N uplink positioning signal resource groups being within a fourth error range.

In some embodiments, at least one of the first error range, the second error range, the third error range, or the fourth error range may be default, configured, or predefined.

In some embodiments, the first error range may mean that the errors in the first error range are sufficiently small, for example, less than a threshold, or negligible within a specific error range.

In some embodiments, the second error range may mean that the errors in the second error range are sufficiently small, for example, less than a threshold, or negligible within a specific error range.

In some embodiments, the third error range may mean that the errors in the third error range are sufficiently small, for example, less than a threshold, or negligible within a specific error range.

In some embodiments, the fourth error range may mean that the errors in the fourth error range are sufficiently small, for example, less than a threshold, or negligible within a specific error range.

In some embodiments, the N uplink positioning signal resource groups further include a second uplink positioning signal resource group, and a transmit timing of an uplink positioning signal corresponding to an uplink positioning signal resource in the second uplink positioning signal resource group is determined based on a second TA value.

The second TA value is different from or the same as the first TA value.

In some embodiments, determining the second TA value is similar to determining the first TA value.

In some embodiments, the second TA value does not include a serving link TA value, or the second TA value is not determined based on the serving link TA value.

In some embodiments, the second TA value includes a feeder link TA value, or the second TA value is determined based on the feeder link TA value.

In some embodiments, the second TA value includes a public serving link TA value, or the second TA value is determined based on the public serving link TA value. The public serving link TA value satisfies at least one of:
the public serving link TA value being configured;
the public serving link TA value being predefined, for example, predefined in a communication protocol;
the public serving link TA value being a serving link TA value of the terminal device at a second instant;
the public serving link TA value being a serving link TA value corresponding to a second reference position; or
the public serving link TA value being a serving link TA value corresponding to the second reference position and the second instant.

The second reference position is a predefined position or a configured position. For example, the second reference position is the center of a cell.

In some embodiments, a number of the uplink positioning signal resources in each of the N uplink positioning signal resource groups is uniformly configured or is the same.

In some embodiments, a number of the uplink positioning signal resources in each of the N uplink positioning signal resource groups is independently configured or is different.

In some embodiments, transmit spatial information of uplink positioning signals corresponding to each of the N uplink positioning signal resource groups is independently configured.

In some embodiments, a downlink path loss calculation parameter corresponding to each of the N uplink positioning signal resource groups is independently configured.

In some embodiments, the uplink positioning signal resources include a positioning SRS resource and/or a MIMO SRS resource.

It should be noted that in the NTN system, the serving satellite positions at different instants are equivalent to TRPs or virtual TRPs, and the terminal device acquires synchronization information between the terminal device and the serving satellite. Therefore, in some cases (for example, when only one serving satellite is present), other uplink channels or uplink signals, besides SRS resources, can also be configured to implement the positioning function.

In some embodiments, the uplink positioning signal resources include at least one of: a positioning SRS resource, a MIMO SRS resource, a PRACH resource, or a demodulation reference signal (DMRS) resource. Optionally, the DMRS resource includes at least one of a DMRS resource corresponding to a physical uplink shared channel (PUSCH) or a DMRS resource corresponding to a physical uplink control channel (PUCCH).

For example, the M uplink positioning signal resources include the positioning SRS resource and the PRACH resource.

For another example, the N uplink positioning signal resource groups include at least two uplink positioning signal resource groups. The uplink positioning signal resources in one uplink positioning signal resource group are SRS resources, and uplink positioning signal resources in the other uplink positioning signal resource group are PRACH resources.

In some embodiments, transmitting the uplink positioning signal on the uplink positioning signal resource based on the TA value includes: transmitting the uplink positioning signal on at least one of the M uplink positioning signal resources based on a third TA value, wherein M is an integer greater than or equal to 1.

In some embodiments, in the case that the uplink positioning signal is transmitted on an uplink positioning signal resource k in the M uplink positioning signal resources, the third TA value includes a feeder link TA value corresponding to an instant k and/or a serving link TA value corresponding to the instant k.

The instant k corresponds to a transmit instant of the uplink positioning signal resource k.

In some embodiments, the terminal device further reports at least one of:
an instant k1, an instant k2, a third TA value corresponding to the instant k1, a third TA value corresponding to the instant k2, a difference between the third TA value corresponding to the instant k1 and the third TA value corresponding to the instant k2, or a difference between the third TA value corresponding to the instant k1 and a third TA value corresponding to a reference instant;
The instant k1 corresponds to a transmit instant of an uplink positioning signal resource k1 in the M uplink positioning signal resources, the instant k2 corresponds to a transmit instant of an uplink positioning signal resource k2 in the M uplink positioning signal resources, and the uplink positioning signal resource k1 and the uplink positioning signal resource k2 are uplink positioning signal resources corresponding to different transmission time units.

The reference instant is predefined or configured.

In some embodiments, determining of the TA value is related to at least one of:
a TA value N_{TA} indicated by a network device, an offset value N_{TA,offset} of N_{TA}, a feeder link TA value N_{TA,adj}^{common}, or a sampling time interval unit T_{c}.

In conclusion, according to the method according to the embodiments, the terminal device transmits the uplink positioning signal on the uplink positioning signal resource based on the TA value, such that the network device/LMF is supported to estimate the time deviation in signal transmission between the serving satellite and the terminal device at different instants, or the terminal device is supported to report the time deviation in signal transmission between the serving satellite and the terminal device at different instants, thereby enabling positioning of the terminal device in the NTN system. In addition, the positioning method is implemented in different NTN scenarios due to the flexible relationship between the determining of the TA value, the serving link TA value, and the feeder link TA value.

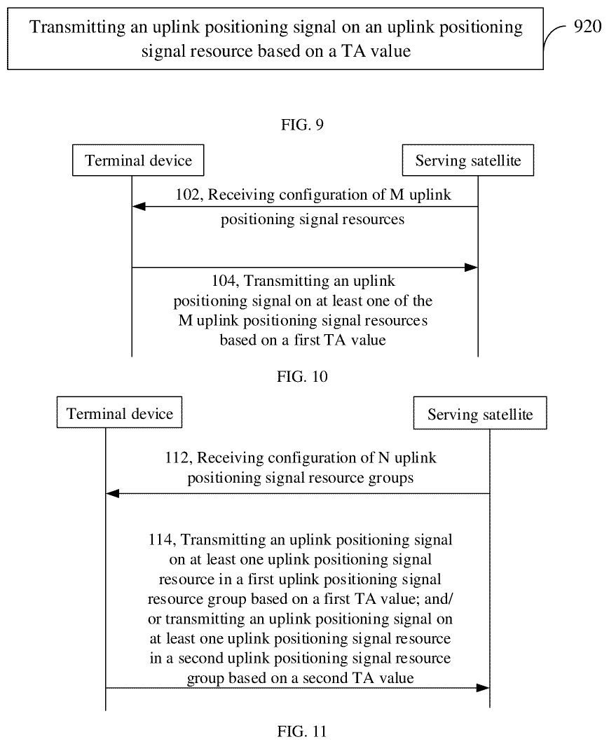

FIG. 10 is a schematic flowchart of a wireless communication method for positioning according to some exemplary embodiments of the present disclosure. For example, the method is executed by a terminal device, and the method includes at least some of the following processes.

In 102, configuration of M uplink positioning signal resources is received.

M is an integer greater than or equal to 1.

The terminal device is a terminal device in an NTN system, such as the terminal device 710 shown in FIG. 7.

In some embodiments, the configuration of the M uplink positioning signal resources is determined based on first configuration information. Optionally, the first configuration information is transmitted to the terminal device by a network device or an LMF.

The terminal device is a terminal device in the NTN system or an evolved system of the NTN system, such as the terminal device 710 shown in FIG. 7.

In some embodiments, the uplink positioning signal resources include at least one of a positioning SRS resource or a MIMO SRS resource.

In some embodiments, the uplink positioning signal resources include at least one of: a positioning SRS resource, a MIMO SRS resource, a PRACH resource, or a DMRS resource. Optionally, the DMRS resource includes at least one of a DMRS resource corresponding to a PUSCH or a DMRS resource corresponding to a PUCCH.

In some embodiments, M is an integer greater than or equal to 2.

In 104, an uplink positioning signal is transmitted on at least one of the M uplink positioning signal resources based on a first TA value.

The uplink positioning signal is transmitted by the terminal device to a serving satellite, which is the serving satellite 720 shown in FIG. 7.

In some embodiments, the first TA value does not include a serving link TA value, or the first TA value is not determined based on the serving link TA value.

In some embodiments, the first TA value includes a feeder link TA value, or the first TA value is determined based on the feeder link TA value.

In some embodiments, the first TA value includes a public serving link TA value, or the first TA value is determined based on the public serving link TA value. The public serving link TA value satisfies at least one of:
the public serving link TA value being configured;
the public serving link TA value being predefined, for example, predefined in a communication protocol;
the public serving link TA value being a serving link TA value of the terminal device at a first instant;
the public serving link TA value being a serving link TA value corresponding to a first reference position; or
the public serving link TA value being a serving link TA value corresponding to the first reference position and the first instant.

The first reference position is a predefined position or a configured position. For example, the first reference position is the center of a cell.

In some embodiments, the first TA value corresponds to the first instant. The first instant satisfies at least one of:
the first instant being configured;
the first instant corresponding to a first uplink positioning signal resource in the M uplink positioning signal resources; or
the first instant corresponding to a transmit instant of the first uplink positioning signal resource in the M uplink positioning signal resources.

In some embodiments, the first uplink positioning signal resource in the M uplink positioning signal resources is predefined or configured.

In some embodiments, a first uplink positioning signal is transmitted on the first uplink positioning signal resource in the M uplink positioning signal resources based on the first TA value, and the first instant corresponds to the first uplink positioning signal resource.

In some embodiments, M uplink positioning signals are transmitted on the M uplink positioning signal resources based on the first TA value.

In some embodiments, when transmitting the uplink positioning signal on an uplink positioning signal resource k in the M uplink positioning signal resources, the first TA value includes a feeder link TA value corresponding to an instant k.

The instant k corresponds to a transmit instant of the uplink positioning signal resource k.

As a specific example but not limitation, the equation for calculating the TA value for transmitting the uplink positioning signal by the terminal device is shown in the following equation (3):

$${T}_{TA} = ( {N}_{TA} + {N}_{TA , offset} + {N}_{TA , adj}^{common} ) {T}_{c} \qquad ( 3 )$$

wherein N_{TA} represents the TA value indicated by the network device, for example, a TA value issued over a TA command. In the case that the uplink channel or uplink signal includes a PRACH or MsgA transmission, N_{TA} takes the value of 0.

N_{TA,offset} is equal to the value in the related art, for example, the value is determined based on the coexistence of the LTE or NR with the fabric band.

N_{TA,common} is acquired based on a public TA value parameter (for example, at least one of the public timing value, a public timing value offset, or a change rate of the public timing value offset) of a higher-layer configuration. In the case that the public TA value parameter is not configured, the value of N_{TA,adj}^{common} take the value of 0. In some cases, N_{TA,adj}^{common} is also referred to as a feeder link TA value.

T_{c} indicates a sampling time interval unit, and T_{c}=1/(480*1000*4096).

Optionally, the terminal device determines the first TA value corresponding to the first instant based on the above equation (3), and transmits the uplink positioning signal on at least one of the M uplink positioning signal resources based on the first TA value.

Transmitting the uplink positioning signal on the at least one of the M uplink positioning signal resources based on the first TA value includes: transmitting the first uplink positioning signal on the first uplink positioning signal resource in the M uplink positioning signal resources based on the first TA value; or transmitting the M uplink positioning signals on the M uplink positioning signal resources based on the first TA value.

The first instant corresponds to the first uplink positioning signal resource, or the first instant is configured or predefined.

Optionally, the terminal device determines the TA value corresponding to the instant k based on the above equation (3), and transmits an uplink positioning signal k through the uplink positioning signal resource k in the M uplink positioning signal resources based on the TA value corresponding to the instant k. The uplink positioning signal resource k corresponds to the instant k.

As another specific example, but not limitation, the equation for calculating the TA value for transmitting the uplink positioning signal by the terminal device is shown in the following equation (4):

$${T}_{TA} = ( {N}_{TA} + {N}_{TA , offset} + {N}_{TA , adj}^{common} + {N}_{TA , ref}^{UE} ) {T}_{c} \qquad ( 4 )$$

Wherein N_{TA} represents the TA value indicated by the network device, for example, a TA value issued by using a TA command. In the case that the uplink channel or uplink signal includes a PRACH or MsgA transmission, N_{TA} takes the value of 0.

N_{TA,offset} is equal to the value in the related art, for example, the value is determined based on the coexistence of the LTE or NR with the fabric band.

N_{TA,adj}^{common} is acquired based on a public TA value parameter (for example, at least one of a public timing value, a public timing value offset, or a change rate of the public timing value offset) of a higher-layer configuration. In the case that the public TA value parameter is not configured, N_{TA,adj}^{common} takes the value of 0. In some cases, N_{TA,adj}^{common} is also referred to as a feeder link TA value.

N_{TA,ref}^{UE} represents public serving link TA value calculated based on the position of the terminal device and serving satellite ephemeris information of a higher-layer configuration. In the case that the serving satellite ephemeris information is not configured, N_{TA,ref}^{UE} takes the value of 0. Optionally, N_{TA,ref}^{UE} corresponds to the first instant. Optionally, N_{TA,ref}^{UE} does not change with time.

T_{c} indicates a sampling time interval unit, and T_{c}=1/(480*1000*4096).

Optionally, the terminal device determines the first TA value corresponding to the first instant based on the above equation (4), and transmits the uplink positioning signal on the at least one of the M uplink positioning signal resources based on the first TA value.

Transmitting the uplink positioning signal on the at least one of the M uplink positioning signal resources based on the first TA value includes: transmitting the first uplink positioning signal on the first uplink positioning signal resource in the M uplink positioning signal resources based on the first TA value; or transmitting the M uplink positioning signals on the M uplink positioning signal resources based on the first TA value.

The first instant corresponds to the first uplink positioning signal resource, or the first instant is configured or predefined.

Optionally, the terminal device determines the TA value corresponding to the instant k based on the above equation (4), and transmits an uplink positioning signal k through the uplink positioning signal resource k in the M uplink positioning signal resources based on the TA value corresponding to the instant k. The uplink positioning signal resource k corresponds to the instant k.

In conclusion, according to the method according to the embodiments, the terminal device transmits the uplink positioning signal on the at least one of the M uplink positioning signal resources based on the TA value, such that the network device/LMF is supported to estimate the time deviation in signal transmission between the serving satellite and the terminal device at different instants, thereby enabling positioning of the terminal device in the NTN system. In addition, the positioning method is implemented in different NTN scenarios due to the flexible relationship between the determining of the TA value, the serving link TA value, and the feeder link TA value.

As mentioned above, in the TN system, for the UL-TDOA positioning method, it can be assumed that the transmit timing errors of the uplink positioning signals transmitted by the ˜Tx terminal device to different (virtual) TRPs are equal, that is, τUE,1=τUE,2·=τUE,M However, in the NTN system, factors such as large signal transmission delays and satellite movement require the terminal device to frequently adjust the TA value. Consequently, the TA values at different instants may vary significantly. Therefore, the NTN system cannot make the same assumption as the TN system, the positioning method used in the NTN system needs to be enhanced.

The present disclosure further provides the following UL-TDOA positioning method suitable for the NTN scenario.

FIG. 11 is a schematic flowchart of a wireless communication method for positioning according to some exemplary embodiments of the present disclosure.

This method can be applied to the positioning system 700 shown in FIG. 7, and the serving satellite 720 in the positioning system 700 includes at least one virtual TRP group, and each of virtual TRP groups includes at least one virtual TRP.

The transmit timing errors corresponding to uplink positioning signals transmitted by a terminal device to the virtual TRPs in a same virtual TRP group are sufficiently small (for example, less than a first threshold or negligible); and/or measurement timing errors corresponding to measurement results acquired by the network device/LMF in measuring the virtual TRPs in the same virtual TRP group are sufficiently small (for example, less than a second threshold or negligible). Thus, higher positioning precision is acquired by applying the method.

Alternatively, the virtual TRP group corresponds to a consecutive time period, such as a first consecutive time period. In the first consecutive time period, timing errors of uplink positioning signals transmitted by the terminal device are sufficiently small (such as less than a third threshold or negligible), such that the positioning method in the NTN scenario reuses the assumption in the positioning method in the TN scenario. That is, it is assumed that the transmit timing errors at different instants are equal.

Optionally, at least one of the first threshold, the second threshold, or the third threshold is default, configured, or predefined.

The embodiment is illustrated as an example of each of the virtual TRP groups including TRPs corresponding to at least two different instants. The virtual TRP group i includes TRP i of a serving satellite position at an instant ti and TRP i′ of a serving satellite position at an instant ti′. A distance between TRP i and the terminal device is dᵢ, and a distance between TRP i′ and the terminal device is dᵢ′, wherein i=0, 1, 2, . . . , M−1. In each virtual TRP group, TRP i is regarded as a reference TRP. As shown in FIG. 7, a distance between TRP 0 and the terminal device is d0, a distance between TRP 0′ and the terminal device is d0′, a distance between TRP 1 and the terminal device is d1, a distance between TRP 1′ and the terminal device is d1′, a distance between TRP 2 and the terminal device is d2, a distance between TRP 2′ and the terminal device is d2′, a distance between TRP 3 and the terminal device is d3, and a distance between TRP 3′ and the terminal device is d3′.

As a specific example but not limitation, measurement for the same TRP group is performed within the first consecutive time period, or the error between the measurement results of the same TRP group can be ignored.

As a specific example but not limitation, the transmit instants corresponding to uplink positioning signals (such as SRS signals) of the same TRP group are within the first consecutive time period, or the timing errors of the transmit instants corresponding to the uplink positioning signals (such as SRS signals) of the same TRP group are ignored.

The positioning system to which the wireless communication method according to the embodiments is applicable can be applied to, but not limited to at least one of: the DL-TDOA positioning method, the UL-TDOA positioning method, or the Multi-RTT positioning method.

For the UL-TDOA positioning method, the equation (2) is enhanced as shown in the following equation (5):

$${TDOA}_{i} = {TOA}_{i ′} - {TOA}_{i} = \frac{\sqrt[2]{{( {x}_{i ′} - {x}_{UE} )}^{2} + {( {y}_{i ′} - {y}_{UE} )}^{2} + {( {z}_{i ′} - {z}_{UE} )}^{2}}}{c} + {n}_{i ′} - \frac{\sqrt[2]{{( {x}_{i} - {x}_{UE} )}^{2} + {( {y}_{i} - {y}_{UE} )}^{2} + {( {z}_{i} - {z}_{UE} )}^{2}}}{c} - {n}_{i} \qquad ( 5 )$$

c indicates the speed of light, and nᵢ and nᵢ, indicate the errors.

For example, the wireless communication method according to the embodiments is executed by the terminal device, and the method includes at least some of the following processes.

In 112, configuration of N uplink positioning signal resource groups is received.

N is an integer greater than or equal to 1.

In some embodiments, the configuration of the N uplink positioning signal resource groups is determined based on second configuration information. Optionally, the second configuration information is transmitted to the terminal device by a network device or an LMF.

The terminal device is a terminal device in the NTN system or an evolved system of the NTN system, such as the terminal device 710 shown in FIG. 7.

In some embodiments, the uplink positioning signal resources include at least one of a positioning SRS resource or a MIMO SRS resource.

In some embodiments, the uplink positioning signal resources include at least one of: a positioning SRS resource, a MIMO SRS resource, a PRACH resource, or a DMRS resource. Optionally, the DMRS resource includes at least one of a DMRS resource corresponding to a PUSCH or a DMRS resource corresponding to a PUCCH.

For example, the terminal device receives configuration of N positioning SRS resource groups.

In some embodiments, the N uplink positioning signal resource groups include at least one of a first uplink positioning signal resource group or a second uplink positioning signal resource group.

In some embodiments, the first uplink positioning signal resource group includes M uplink positioning signal resources, wherein M is an integer greater than or equal to 1.

In some embodiments, N is an integer greater than or equal to 4.

In some embodiments, M is an integer greater than or equal to 2.

In 114, an uplink positioning signal is transmitted on at least one uplink positioning signal resource in the first uplink positioning signal resource group based on a first TA value; and/or an uplink positioning signal is transmitted on at least one uplink positioning signal resource in the second uplink positioning signal resource group based on a second TA value.

The uplink positioning signal is transmitted by the terminal device to a serving satellite, which is the serving satellite 720 shown in FIG. 7.

In some embodiments, the uplink positioning signal resources in the first uplink positioning signal resource group satisfy at least one of:
transmit timing errors of uplink positioning signals corresponding to the uplink positioning signal resources in the first uplink positioning signal resource group being within a first error range; or
receive timing errors of the uplink positioning signals corresponding to the uplink positioning signal resource in the first uplink positioning signal resource group being within a second error range.

In some embodiments, uplink positioning signal resources in each of the N uplink positioning signal resource groups satisfy at least one of:
transmit timing errors of uplink positioning signals corresponding to the uplink positioning signal resources in each of the N uplink positioning signal resource groups being within a third error range; or
receive timing errors of the uplink positioning signals corresponding to the uplink positioning signal resources in each of the N uplink positioning signal resource groups being within a fourth error range.

In some embodiments, at least one of the first error range, the second error range, the third error range, or the fourth error range is default, configured, or predefined.

In some embodiments, the first error range indicates that the errors in the first error range are sufficiently small, for example, less than a threshold, or negligible within a specific error range.

In some embodiments, the second error range may mean that the errors in the second error range are sufficiently small, for example, less than a threshold, or negligible within a specific error range.

In some embodiments, the third error range may mean that the errors in the third error range are sufficiently small, for example, less than a threshold, or negligible within a specific error range.

In some embodiments, the fourth error range may mean that the errors in the fourth error range are sufficiently small, for example, less than a threshold, or negligible within a specific error range.

In some embodiments, the N uplink positioning signal resource groups further include a second uplink positioning signal resource group, and a transmit timing of an uplink positioning signal corresponding to an uplink positioning signal resource in the second uplink positioning signal resource group is determined based on a second TA value.

The second TA value is different from or the same as the first TA value.

In some embodiments, determining of the second TA value is similar to determining of the first TA value.

In some embodiments, the second TA value does not include a serving link TA value, or the second TA value is not determined based on the serving link TA value.

In some embodiments, the second TA value includes a feeder link TA value, or the second TA value is determined based on the feeder link TA value.

In some embodiments, the second TA value includes a public serving link TA value, or the second TA value is determined based on the public serving link TA value. The public serving link TA value satisfies at least one of:
the public serving link TA value being configured;
the public serving link TA value being predefined, for example, predefined in a communication protocol;
the public serving link TA value being a serving link TA value of the terminal device at a second instant;
the public serving link TA value being a serving link TA value corresponding to a second reference position; or
the public serving link TA value being a serving link TA value corresponding to the second reference position and the first instant.

The second reference position is a predefined position or a configured position. For example, the second reference position is the center of a cell.

In some embodiments, a number of the uplink positioning signal resources in each of the N uplink positioning signal resource groups is uniformly configured or is the same.

In some embodiments, a number of the uplink positioning signal resources in each of the N uplink positioning signal resource groups is independently configured or is different.

In some embodiments, transmit spatial information of uplink positioning signals corresponding to each of the N uplink positioning signal resource groups is independently configured.

In some embodiments, a downlink path loss calculation parameter corresponding to each of the N uplink positioning signal resource groups is independently configured.

In conclusion, according to the method according to the embodiments, the terminal device transmits the uplink positioning signal on the at least one of the N uplink positioning signal resource groups based on the TA value, such that the network device/LMF is supported to estimate the time deviation in signal transmission between the serving satellite and the terminal device at different instants, thereby enabling positioning of the terminal device in the NTN system. In addition, the positioning method is implemented in different NTN scenarios due to the flexible relationship between the determining of the TA value, the serving link TA value, and the feeder link TA value. Because the timing errors of the uplink positioning signals transmitted by the terminal device to the same TRP group and/or the timing errors corresponding to measurement results of the same TRP group are sufficiently small, higher positioning precision is acquired on the basis of reusing the assumption of the positioning method in the TN system.

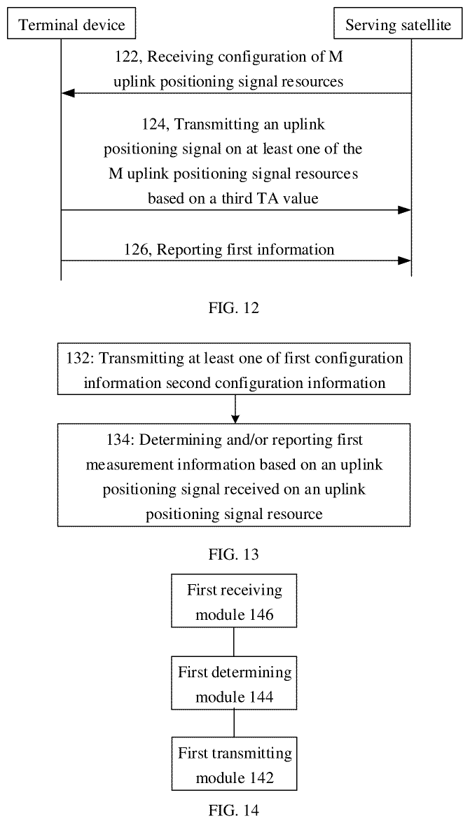

FIG. 12 is a schematic flowchart of a wireless communication method for positioning according to some exemplary embodiments of the present disclosure. For example, the method is executed by a terminal device, and the method includes at least some of the following processes.

In 122, configuration of M uplink positioning signal resources is received.

M is an integer greater than or equal to 1.

In some embodiments, the configuration of the M uplink positioning signal resources is determined based on first configuration information. Optionally, the first configuration information is transmitted to the terminal device by a network device or an LMF.

The terminal device may be a terminal device in the NTN system or an evolved system of the NTN system, such as the terminal device 710 shown in FIG. 7.

In some embodiments, the uplink positioning signal resources include at least one of a positioning SRS resource or a MIMO SRS resource.

In some embodiments, the uplink positioning signal resources include at least one of: a positioning SRS resource, a MIMO SRS resource, a PRACH resource, or a DMRS resource. Optionally, the DMRS resource includes at least one of a DMRS resource corresponding to a PUSCH or a DMRS resource corresponding to a PUCCH.

In some embodiments, M is an integer greater than or equal to 2.

In step 124, an uplink positioning signal is transmitted on at least one of the M uplink positioning signal resources based on a third TA value.

The uplink positioning signal is transmitted by the terminal device to a serving satellite, which is the serving satellite 720 shown in FIG. 7.

In some embodiments, in the case that the uplink positioning signal is transmitted on an uplink positioning signal resource k in the M uplink positioning signal resources, the third TA value includes at least one of a feeder link TA value corresponding to an instant k or a serving link TA value corresponding to the instant k.

The instant k corresponds to a transmit instant of the uplink positioning signal resource k.

In some embodiments, determining the third TA value is related to at least one of: the TA value N_{TA} indicated by the network device, an offset value N_{TA,offset} of N_{TA}, a feeder link TA value N_{TA, adj}^{common}, or a sampling time interval unit T_{c}.

In step 126, first information is reported.

The first information includes at least one of:
an instant k1, an instant k2, a third TA value corresponding to the instant k1, a third TA value corresponding to the instant k2, a difference between the third TA value corresponding to the instant k1 and the third TA value corresponding to the instant k2, or a difference between the third TA value corresponding to the instant k1 and a third TA value corresponding to a reference instant;
The instant k1 corresponds to a transmit instant of an uplink positioning signal resource k1 in the M uplink positioning signal resources, the instant k2 corresponds to a transmit instant of an uplink positioning signal resource k2 in the M uplink positioning signal resources, and the uplink positioning signal resource k1 and the uplink positioning signal resource k2 are uplink positioning signal resources corresponding to different transmission time units.

The reference instant is predefined or configured.

In some embodiments, the terminal device reports N_{TA,adj}^{common}(ti). ti indicates a serving link TA value corresponding to an instant i. The instant i is configured or predefined.

In some embodiments, the terminal device reports N_{TA,adj}^{common}(ti)−N_{TA,adj}^{common}(ti). tj indicates a serving link TA value corresponding to an instant j, and ti indicates a serving link TA value corresponding to an instant i. The instant j is configured or predefined, and the instant i is configured or predefined.

In some embodiments, the terminal device reports N_{TA,adj}^{common}(ti)−N_{TA,adj}^{common}(t0). t0 indicates a serving link TA value corresponding to a reference instant, and ti indicates a serving link TA value corresponding to an instant i. The instant 0 is configured or predefined, and the instant i is configured or predefined.

In conclusion, according to the method according to the embodiments, the terminal device transmits the uplink positioning signal on the uplink positioning signal resource based on the TA value, such that the terminal device is supported to report the time deviation in signal transmission between the serving satellite and the terminal device at different instants, thereby assisting the network device/LMF achieving positioning of the terminal device in the NTN system. In addition, the positioning method is implemented in different NTN scenarios due to the flexible relationship between the determining of the TA value, the serving link TA value, and the feeder link TA value.

FIG. 13 is a schematic flowchart of a wireless communication method for positioning according to some exemplary embodiments of the present disclosure. For example, the method is executed by a network device, and the method includes at least some of the following processes.

In 132, at least one of first configuration information or second configuration information is transmitted.

The first configuration information is transmitted by the network device to a terminal device, and is used by the terminal device to determine M uplink positioning signal resources.

The second configuration information is transmitted by the network device to the terminal device, and is used by the terminal device to determine N uplink positioning signal resource groups.

The network device is a network device in an NTN system or an evolved system of the NTN system, such as the network device 730 shown in FIG. 7.

In some embodiments, the uplink positioning signal resources include at least one of a positioning SRS resource or a MIMO SRS resource.

In some embodiments, the uplink positioning signal resources include at least one of: a positioning SRS resource, a MIMO SRS resource, a PRACH resource, or a DMRS resource. Optionally, the DMRS resource includes at least one of a DMRS resource corresponding to a PUSCH or a DMRS resource corresponding to a PUCCH.

For example, M positioning SRS resources are configured for the terminal device through the first configuration information, or N positioning SRS resource groups are configured for the terminal device through the second configuration information.

For another example, M positioning SRS resources are configured for the terminal device through the first configuration information, and a positioning SRS resource group identifier is configured for each of the M positioning SRS resources through the second configuration information.

In some embodiments, the first configuration information carries the configuration of the M uplink positioning signal resources, wherein M is an integer greater than or equal to 1.

In some embodiments, the second configuration information carries the configuration of the N uplink positioning signal resource groups, and N is an integer greater than or equal to 1. Optionally, the N uplink positioning signal resource groups include at least one of a first uplink positioning signal resource group or a second uplink positioning signal resource group. Optionally, the first uplink positioning signal resource group includes M uplink positioning signal resources, wherein M is an integer greater than or equal to 1.

In some embodiments, the terminal device further transmits third configuration information, and the third configuration information is used for determining at least one of:
a public serving link TA value;
a first reference position;
a first instant; or
a first uplink positioning signal resource in the M uplink positioning signal resources.

In some embodiments, the third configuration information transmitted to different terminal devices or to the same terminal device at different instants is the same or different.

In some embodiments, the uplink positioning signal resources in the first uplink positioning signal resource group satisfy at least one of:
transmit timing errors of uplink positioning signals corresponding to the uplink positioning signal resources in the first uplink positioning signal resource group being within a first error range; or
receive timing errors of the uplink positioning signals corresponding to the uplink positioning signal resource in the first uplink positioning signal resource group being within a second error range.

In some embodiments, uplink positioning signal resources in each of the N uplink positioning signal resource groups satisfy at least one of:
transmit timing errors of uplink positioning signals corresponding to the uplink positioning signal resources in each of the N uplink positioning signal resource groups being within a third error range; or
receive timing errors of the uplink positioning signals corresponding to the uplink positioning signal resources in each of the N uplink positioning signal resource groups being within a fourth error range.

In some embodiments, at least one of the first error range, the second error range, the third error range, or the fourth error range is default, configured, or predefined.

In some embodiments, the first error range may mean that the errors in the first error range are sufficiently small, for example, less than a threshold, or negligible within a specific error range.

In some embodiments, the second error range may mean that the errors in the second error range are sufficiently small, for example, less than a threshold, or negligible within a specific error range.

In some embodiments, the third error range may mean that the errors in the third error range are sufficiently small, for example, less than a threshold, or negligible within a specific error range.

In some embodiments, the fourth error range may mean that the errors in the fourth error range are sufficiently small, for example, less than a threshold, or negligible within a specific error range.

In some embodiments, the N uplink positioning signal resource groups further include a second uplink positioning signal resource group.

In some embodiments, a number of the uplink positioning signal resources in each of the N uplink positioning signal resource groups is uniformly configured or is the same.

In some embodiments, a number of the uplink positioning signal resources in each of the N uplink positioning signal resource groups is independently configured or is different.

In some embodiments, transmit spatial information of uplink positioning signals corresponding to each of the N uplink positioning signal resource groups is independently configured.

In some embodiments, a downlink path loss calculation parameter corresponding to each of the N uplink positioning signal resource groups is independently configured.

In step 134, the first measurement information is determined and/or reported based on the uplink positioning signal received on the uplink positioning signal resource.

In some embodiments, the network device receives the uplink positioning signal on the uplink positioning signal resource, and/or the network device receives the first measurement information.

In some embodiments, the uplink positioning signal is transmitted by the serving satellite (a serving satellite in an NTN system, such as the serving satellite 720 shown in FIG. 7) to the network device.

In some embodiments, the first measurement information is transmitted by the serving satellite (a serving satellite in an NTN system, such as the serving satellite 720 shown in FIG. 7) to the network device.

In some embodiments, the network device refers to an access network device, and the network device has the ability to calculate or estimate the position of the terminal device.

In some embodiments, the first measurement information is determined based on the uplink positioning signal received on at least one of the M uplink positioning signal resources, the position of the terminal device is determined based on the first measurement information, and the positioning result of the terminal device is reported to a core network device (such as an LMF).

In some embodiments, the first measurement information is determined based on the uplink positioning signal received on at least one uplink positioning signal resource in at least one of the N uplink positioning signal resource groups, the position of the terminal device is determined based on the first measurement information, and the positioning result of the terminal device is reported to a core network device (such as an LMF).

In some embodiments, the network device refers to an access network device, and the network device does not have the ability to calculate or estimate the position of the terminal device. The network device reports the first measurement information to the core network device (such as an LMF), which calculates or estimates the position of the terminal device.

In some embodiments, the first measurement information is reported based on the uplink positioning signal received on at least one of the M uplink positioning signal resources, and the core network device (such as an LMF) determines the position of the terminal device based on the first measurement information, that is, acquires the positioning result of the terminal device.

In some embodiments, the first measurement information is reported based on the uplink positioning signal received on at least one of the N uplink positioning signal resource groups, the core network device (such as an LMF) determines the position of the terminal device based on the first measurement information, that is, acquires the positioning result of the terminal device.

In some embodiments, the first measurement information includes at least one of: a start position of an uplink time unit k, a UTC corresponding to the start position of the uplink time unit k, or a UL RTOA corresponding to the uplink time unit k.

The uplink time unit k is a time unit corresponding to an uplink positioning signal resource k in the M uplink positioning signal resources, or the uplink time unit k is a time unit corresponding to an uplink positioning signal resource k in the N uplink positioning signal resource groups.

In some embodiments, the first measurement information includes at least one of: a start position of an uplink time unit k1, a UTC corresponding to the start position of the uplink time unit k1, a start position of an uplink time unit k2, a UTC corresponding to the start position of the uplink time unit k2, or a difference between the start position of the uplink time unit k1 and the start position of the uplink time unit k2.

The uplink time unit k1 is a time unit corresponding to an uplink positioning signal resource k1 in the M uplink positioning signal resources, the uplink time unit k2 is a time unit corresponding to an uplink positioning signal resource k2 in the M uplink positioning signal resources, and the uplink positioning signal resource k1 and the uplink positioning signal resource k2 are uplink positioning signal resources corresponding to different transmission time units. Alternatively, the uplink time unit k1 is a time unit corresponding to an uplink positioning signal resource k1 in the N uplink positioning signal resource groups, the uplink time unit k2 is a time unit corresponding to an uplink positioning signal resource k2 in the N uplink positioning signal resource groups, and the uplink positioning signal resource k1 and the uplink positioning signal resource k2 are uplink positioning signal resources corresponding to different transmission time units.

In some embodiments, the uplink transmission unit is determined based on one of: an uplink timing at a serving satellite (such as a satellite, TRP, TP, or virtual TRP), an uplink timing of a reference point, or an uplink timing at the network device (such as an access network device or a base station).

In conclusion, according to the method according to the embodiments, the network device receives the uplink positioning signal transmitted by the terminal device on the uplink positioning signal resource based on the TA value and/or the first measurement information from the serving satellite, such that the LMF is supported to estimate or achieve the position of the terminal device, thereby enabling positioning of the terminal device in the NTN scenario. In addition, the positioning method is implemented in different NTN scenarios due to the flexible methods for configuring the uplink positioning signal resources and estimating the position of the terminal device.

FIG. 14 is a block diagram of a wireless communication apparatus for positioning according to some exemplary embodiments of the present disclosure. For example, the apparatus is applied to a terminal device and includes at least one of a first transmitting module 142, a first determining module 144, or a first receiving module 146.

The first transmitting module 142 is configured to transmit an uplink positioning signal on an uplink positioning signal resource based on a TA value.

In some embodiments, the first transmitting module 142 is further configured to transmit the uplink positioning signal on at least one of M uplink positioning signal resources based on a first TA value, wherein M is an integer greater than or equal to 1.

In some embodiments, the first TA value does not include a serving link TA value, or the first TA value is not determined based on the serving link TA value.

In some embodiments, the first TA value includes a feeder link TA value, or the first TA value is determined based on the feeder link TA value.

In some embodiments, the first TA value includes a public serving link TA value, or the first TA value is determined based on the public serving link TA value. The public serving link TA value satisfies at least one of:
the public serving link TA value being configured;
the public serving link TA value being predefined;
the public serving link TA value being a serving link TA value of the terminal device at a first instant;
the public serving link TA value being a serving link TA value corresponding to a first reference position; or
the public serving link TA value being a serving link TA value corresponding to the first reference position and the first instant.

In some embodiments, the first reference position is a predefined position or a configured position.

In some embodiments, the first TA value corresponds to the first instant, and the first instant satisfies at least one of:
the first instant being configured;
the first instant corresponding to a first uplink positioning signal resource in the M uplink positioning signal resources; or
the first instant corresponding to a transmit instant of the first uplink positioning signal resource in the M uplink positioning signal resources.

In some embodiments, the first uplink positioning signal resource in the M uplink positioning signal resources is predefined or configured.

In some embodiments, the first transmitting module 142 is further configured to transmit a first uplink positioning signal on the first uplink positioning signal resource in the M uplink positioning signal resources based on the first TA value.

The first instant corresponds to the first uplink positioning signal resource.

In some embodiments, the first transmitting module 142 is further configured to transmit M uplink positioning signals on the M uplink positioning signal resources based on the first TA value.

In some embodiments, in the case that the first transmitting module 142 is configured to transmit the uplink positioning signal on an uplink positioning signal resource k in the M uplink positioning signal resources, the first TA value includes a feeder link TA value corresponding to an instant k.

The instant k corresponds to a transmit instant of the uplink positioning signal resource k.

In some embodiments, the apparatus further includes the first determining module 144, used for determining the M uplink positioning signal resources based on first configuration information.

In some embodiments, the apparatus further includes the first receiving module 146 configured to receive the first configuration information.

In some embodiments, the M uplink positioning signal resources are uplink positioning signal resources in a first uplink positioning signal resource group, and the first uplink positioning signal resource group is one of N configured uplink positioning signal resource groups, wherein N is an integer greater than or equal to 1.

In some embodiments, the uplink positioning signal resources in the first uplink positioning signal resource group satisfy at least one of:
transmit timing errors of uplink positioning signals corresponding to the uplink positioning signal resources in the first uplink positioning signal resource group being within a first error range; or
receive timing errors of the uplink positioning signals corresponding to the uplink positioning signal resources in the first uplink positioning signal resource group being within a second error range; or
uplink positioning signal resources in each of the N uplink positioning signal resource groups satisfy at least one of:

transmit timing errors of uplink positioning signals corresponding to the uplink positioning signal resources in each of the N uplink positioning signal resource groups being within a third error range; or
receive timing errors of the uplink positioning signals corresponding to the uplink positioning signal resources in each of the N uplink positioning signal resource groups being within a fourth error range.

In some embodiments, the N uplink positioning signal resource groups further include a second uplink positioning signal resource group, and the first determining module 144 is used for determining, based on a second TA value, a transmit timing of an uplink positioning signal corresponding to an uplink positioning signal resource in the second uplink positioning signal resource group.

The second TA value is different from or the same as the first TA value.

In some embodiments, the first receiving module 142 is further configured to receive a uniformly configured number of the uplink positioning signal resources in each of the N uplink positioning signal resource groups, or a number of the uplink positioning signal resources in each of the N uplink positioning signal resource groups is equal

In some embodiments, the first receiving module 142 is further configured to receive an independently configured number of the uplink positioning signal resources in each of the N uplink positioning signal resource groups, or a number of the uplink positioning signal resources in each of the N uplink positioning signal resource groups is different.

In some embodiments, the first receiving module 142 is further configured to receive independently configured transmit spatial information of uplink positioning signals corresponding to each of the N uplink positioning signal resource groups.

In some embodiments, the first receiving module 142 is further configured to receive an independently configured downlink path loss calculation parameter corresponding to each of the N uplink positioning signal resource groups.

In some embodiments, the uplink positioning signal resources include at least one of a positioning SRS resource or a MIMO SRS resource.

In some embodiments, the first transmitting module 142 is further configured to transmit the uplink positioning signal on at least one of the M uplink positioning signal resources based on a third TA value, wherein M is an integer greater than or equal to 1.

In some embodiments, when the first transmitting module 142 is configured to transmit the uplink positioning signal on an uplink positioning signal resource k in the M uplink positioning signal resources, the third TA value includes at least one of a feeder link TA value corresponding to an instant k or a serving link TA value corresponding to the instant k.

The instant k corresponds to a transmit instant of the uplink positioning signal resource k.

In some embodiments, the first transmitting module 142 is further configured to report at least one of:
an instant k1, an instant k2, a third TA value corresponding to the instant k1, a third TA value corresponding to the instant k2, a difference between the third TA value corresponding to the instant k1 and the third TA value corresponding to the instant k2, or a difference between the third TA value corresponding to the instant k1 and a third TA value corresponding to a reference instant;
wherein the instant k1 corresponds to a transmit instant of an uplink positioning signal resource k1 in the M uplink positioning signal resources, the instant k2 corresponds to a transmit instant of an uplink positioning signal resource k2 in the M uplink positioning signal resources, and the uplink positioning signal resource k1 and the uplink positioning signal resource k2 are uplink positioning signal resources corresponding to different transmission time units.

The reference instant is predefined or configured.

In some embodiments, determining of the TA value is related to at least one of:

a TA value N_{TA} indicated by a network device, an offset value N_{TA,offset} of N_{TA}, a feeder link TA value N_{TA,adj}^{common}, or a sampling time interval unit T_{c}.

In conclusion, according to the apparatus in the embodiments, the terminal device transmits the uplink positioning signal on the uplink positioning signal resource based on the TA value, such that the network device/LMF is supported to estimate the time deviation in signal transmission between the serving satellite and the terminal device at different instants, or the terminal device is supported to report the time deviation in signal transmission between the serving satellite and the terminal device at different instants, thereby enabling positioning of the terminal device in the NTN system. In addition, the positioning method is implemented in different NTN scenarios due to the flexible relationship between the determining of the TA value, the serving link TA value, and the feeder link TA value.

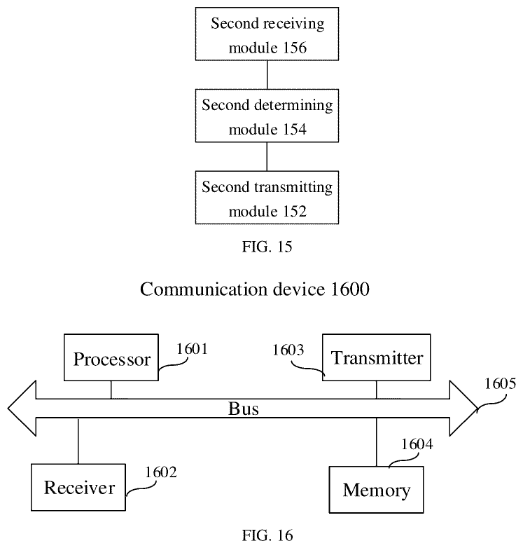

FIG. 15 is a block diagram of a wireless communication apparatus for positioning according to some exemplary embodiments of the present disclosure. For example, the apparatus is applied to a network device and includes at least one of a second transmitting module 152, a second determining module 154, or a second receiving module 156.

The second transmitting module 152 is configured to report first measurement information based on an uplink positioning signal received on an uplink positioning signal resource.

The second determining module 154 is used for determining first measurement information based on the uplink positioning signal received on the uplink positioning signal resource.

The second receiving module 156 is configured to receive the uplink positioning signal on the uplink positioning signal resource, or to receive the first measurement information.

In some embodiments, the first measurement information includes at least one of: a start position of an uplink time unit k, a UTC corresponding to the start position of the uplink time unit k, or a UL RTOA corresponding to the uplink time unit k.

The uplink time unit k is a time unit corresponding to an uplink positioning signal resource k in M uplink positioning signal resources.

In some embodiments, the uplink positioning signal resource k is a first uplink positioning signal resource in the M uplink positioning signal resources; the uplink positioning signal resource k is a last uplink positioning signal resource in the M uplink positioning signal resources; or the uplink positioning signal resource k is an uplink positioning signal resource used for determining the first measurement information in the M uplink positioning signal resources.

In some embodiments, the first measurement information includes at least one of: a start position of an uplink time unit k1, a UTC corresponding to the start position of the uplink time unit k1, a start position of an uplink time unit k2, a UTC corresponding to the start position of the uplink time unit k2, or a difference between the start position of the uplink time unit k1 and the start position of the uplink time unit k2.

The uplink time unit k1 is a time unit corresponding to an uplink positioning signal resource k1 in the M uplink positioning signal resources, the uplink time unit k2 is a time unit corresponding to an uplink positioning signal resource k2 in the M uplink positioning signal resources, and the uplink positioning signal resource k1 and the uplink positioning signal resource k2 are uplink positioning signal resources corresponding to different transmission time units.

In some embodiments, the uplink time unit is determined based on one of: an uplink timing at the serving satellite, an uplink timing of a reference point, or an uplink timing at the network device.

In some embodiments, the second transmitting module 152 is further configured to transmit first configuration information, and the first configuration information is used for determining the M uplink positioning signal resources; and/or the second transmitting module 152 is configured to transmit second configuration information, and the second configuration information is used for determining N uplink positioning signal resource groups, and a first uplink positioning signal resource group in the N uplink positioning signal resource groups includes the M uplink positioning signal resources.

In some embodiments, the second transmitting module 152 is further configured to transmit third configuration information, and the third configuration information is used for determining:
a public serving link TA value;
a first reference position;
a first instant; or
a first uplink positioning signal resource in the M uplink positioning signal resources.

In some embodiments, the M uplink positioning signal resources are uplink positioning signal resources in the first uplink positioning signal resource group, and the first uplink positioning signal resource group is one of the N configured uplink positioning signal resource groups, wherein N is an integer greater than or equal to 1.

In some embodiments, the uplink positioning signal resources in the first uplink positioning signal resource group satisfy at least one of:
transmit timing errors of uplink positioning signals corresponding to the uplink positioning signal resources in the first uplink positioning signal resource group being within a first error range; or
receive timing errors of the uplink positioning signals corresponding to the uplink positioning signal resources in the first uplink positioning signal resource group being within a second error range; or
uplink positioning signal resources in each of the N uplink positioning signal resource groups satisfy at least one of:
transmit timing errors of uplink positioning signals corresponding to the uplink positioning signal resources in each of the N uplink positioning signal resource groups being within a third error range; or
receive timing errors of the uplink positioning signals corresponding to the uplink positioning signal resources in each of the N uplink positioning signal resource groups being within a fourth error range.

In some embodiments, the second transmitting module 152 is further configured to uniformly configure a number of the uplink positioning signal resources corresponding to each of the N uplink positioning signal resource groups; or configured to independently configure the number of the uplink positioning signal resources corresponding to each of the N uplink positioning signal resource groups.

In some embodiments, the second transmitting module 152 is further configured to independently configure transmit spatial information of the uplink positioning signals corresponding to each of the N uplink positioning signal resource groups.

In some embodiments, the second transmitting module 152 is further configured to independently configure a downlink path loss calculation parameter corresponding to each of the N uplink positioning signal resource groups.

In some embodiments, the uplink positioning signal resources include at least one of a positioning SRS resource or a MIMO SRS resource.

In conclusion, according to the apparatus in the embodiments, the terminal device transmits the uplink positioning signal on the uplink positioning signal resource based on the TA value, such that the terminal device is support to report the time deviation in signal transmission between the serving satellite and the terminal device at different instants, thereby assisting the network device/LMF achieving positioning of the terminal device in the NTN system. In addition, the positioning method is implemented in different NTN scenarios due to the flexible relationship between the determining of the TA value, the serving link TA value, and the feeder link TA value.

It should be noted that the apparatus according to the above embodiments is only illustrated by an example of division into the above-mentioned functional modules. In practical application, the above functions are allocated to and completed by different function modules as required, that is, an internal structure of the apparatus is divided into different function modules to complete all or some of the above functions.

Specific manners of operations performed by the modules in the apparatus in the above embodiments have been described in detail in the embodiments of the related method, and details are not described herein again.

FIG. 16 is a schematic structural diagram of a communication device (a terminal device or a network device) according to some exemplary embodiments of the present disclosure. The communication device 1600 includes a processor 1601, a receiver 1602, a transmitter 1603, a memory 1604, and a bus 1605.

The communication device 1600 is configured for positioning, such as positioning in an NTN scenario.

The processor 1601 includes one or more processing cores. The processor 1601 runs a software program and modules to execute various functional applications and information processing.

The receiver 1602 and the transmitter 1603 are implemented as a communication component. The communication component is a communication chip.

The memory 1604 is connected to the processor 1601 through the bus 1605. The memory 1604 is configured to store at least one instruction. The processor 1601 is configured to execute the at least one instruction to implement various processes in the above method embodiments.

In addition, the memory 1604 is implemented by any type of volatile or non-volatile storage device or a combination thereof. The volatile or non-volatile storage device includes but is not limited to a magnetic disk or an optical disc, an electrically erasable programmable read-only memory (EEPROM), an erasable programmable read-only memory (EPROM), a static random-access memory (SRAM), a read-only memory (ROM), a magnetic memory, a flash memory, or a programmable ROM (PROM).

Some exemplary embodiments of the present disclosure further provide a computer-readable storage medium. The computer-readable storage medium stores one or more executable instructions, and the one or more executable instructions, when loaded and executed by a processor, causes the processor to perform the wireless communication method for positioning according to the above method embodiments.

Some exemplary embodiments of the present disclosure further provide a chip. The chip includes at least one programmable logic circuit and/or at least one program instruction. A communication device equipped with the chip, when running, is caused to perform the wireless communication method for positioning according to the above method embodiments.

Some exemplary embodiments of the present disclosure further provide a computer program product or a computer program, storing one or more executable instructions. The one or more executable instructions is stored in a computer-readable storage medium, and a processor of a computer device, when reading the one or more executable instructions from the computer-readable storage medium, and loading and executing the one or more executable instructions, is caused to perform the above wireless communication method for positioning.

Those skilled in the art should be aware that in the above one or more examples, the functions described in the embodiments of the present disclosure may be implemented by hardware, software, firmware, or any combination thereof. When implemented by software, the functions may be stored in a computer-readable medium or transmitted as at least one instruction or code on the computer-readable medium. The computer-readable medium includes a computer storage medium and a communication medium, wherein the communication medium includes any medium that facilitates transfer of a computer program from one place to another. The storage medium may be any available medium to which a general-purpose computer or a special-purpose computer has access.

Described above are merely optional embodiments of the present disclosure and are not intended to limit the present disclosure. Any modification, equivalent replacement, improvements, and the like made within the spirit and principle of the present disclosure shall be included within the protection scope of the present disclosure.

1. A wireless communication method for positioning, applicable to a terminal device, the method comprising:
transmitting an uplink positioning signal on an uplink positioning signal resource based on a timing advance (TA) value.

2. The method according to claim 1, wherein transmitting the uplink positioning signal on the uplink positioning signal resource based on the TA value comprises:
transmitting the uplink positioning signal on at least one of M uplink positioning signal resources based on a first TA value, wherein M is an integer greater than or equal to 1.

3. The method according to claim 2, wherein the first TA value does not comprise a serving link TA value, or the first TA value is not determined based on the serving link TA value; and
the first TA value comprises a feeder link TA value, or the first TA value is determined based on the feeder link TA value.

4. The method according to claim 2, wherein the first TA value comprises a public serving link TA value, or the first TA value is determined based on the public serving link TA value;
wherein the public serving link TA value satisfies at least one of:
the public serving link TA value being configured;
the public serving link TA value being predefined;
the public serving link TA value being a serving link TA value of the terminal device at a first instant;
the public serving link TA value being a serving link TA value corresponding to a first reference position; or
the public serving link TA value being a serving link TA value corresponding to the first reference position and the first instant.

5. The method according to claim 2, wherein the first TA value corresponds to the first instant;
and the first instant satisfies at least one of:
the first instant being configured;
the first instant corresponding to a first uplink positioning signal resource in the M uplink positioning signal resources; or
the first instant corresponding to a transmit instant of the first uplink positioning signal resource in the M uplink positioning signal resources.

6. The method according to claim 2, wherein in a case of transmitting the uplink positioning signal on an uplink positioning signal resource k in the M uplink positioning signal resources, the first TA value comprises a feeder link TA value corresponding to an instant k;
wherein the instant k corresponds to a transmit instant of the uplink positioning signal resource k.

7. The method according to claim 1, wherein transmitting the uplink positioning signal on the uplink positioning signal resource based on the TA value comprises:
transmitting the uplink positioning signal on at least one of M uplink positioning signal resources based on a third TA value, wherein M is an integer greater than or equal to 1.

8. The method according to claim 7, wherein in a case of transmitting the uplink positioning signal on an uplink positioning signal resource k in the M uplink positioning signal resources, the third TA value comprises at least one of a feeder link TA value corresponding to an instant k or a serving link TA value corresponding to the instant k;
wherein the instant k corresponds to a transmit instant of the uplink positioning signal resource k.

9. The method according to claim 7, further comprising:
reporting at least one of:
an instant k1, an instant k2, a third TA value corresponding to the instant k1, a third TA value corresponding to the instant k2, a difference between the third TA value corresponding to the instant k1 and the third TA value corresponding to the instant k2, or a difference between the third TA value corresponding to the instant k1 and a third TA value corresponding to a reference instant;
wherein the instant k1 corresponds to a transmit instant of an uplink positioning signal resource k1 in the M uplink positioning signal resources, the instant k2 corresponds to a transmit instant of an uplink positioning signal resource k2 in the M uplink positioning signal resources, and the uplink positioning signal resource k1 and the uplink positioning signal resource k2 are uplink positioning signal resources corresponding to different transmission time units;
wherein the reference instant is predefined or configured.

10. The method according to claim 1, wherein determining of the TA value is related to at least one of:
a TA value N_{TA} indicated by a network device, an offset value N_{TA,offset} of N_{TA}, a feeder link TA value N_{TA,adj}^{common}, or a sampling time interval unit T_{c}.

11. A wireless communication method for positioning, applicable to a network device, the method comprising:
determining and/or reporting first measurement information based on an uplink positioning signal received on an uplink positioning signal resource.

12. The method according to claim 11, wherein the first measurement information comprises at least one of: a start position of an uplink time unit k, a universal time coordinated (UTC) corresponding to the start position of the uplink time unit k, or an uplink relative time of arrival (UL RTOA) corresponding to the uplink time unit k;
wherein the uplink time unit k is a time unit corresponding to an uplink positioning signal resource k in M uplink positioning signal resources.

13. The method according to claim 11, further comprising:
transmitting third configuration information, wherein the third configuration information is used for determining at least one of:
a public serving link TA value;
a first reference position;
a first instant; or
a first uplink positioning signal resource in the M uplink positioning signal resources.

14. A terminal device, comprising:
a processor;
a transceiver connected to the processor; and
a memory configured to store one or more instructions executable by the processor;
wherein the processor, when loading and executing the one or more executable instructions, is caused to perform a wireless communication method for positioning; and
the method comprises:
transmitting an uplink positioning signal on an uplink positioning signal resource based on a timing advance (TA) value.

15. The terminal device according to claim 14, wherein transmitting the uplink positioning signal on the uplink positioning signal resource based on the TA value comprises:
transmitting the uplink positioning signal on at least one of M uplink positioning signal resources based on a first TA value, wherein M is an integer greater than or equal to 1.

16. The terminal device according to claim 15, wherein the first TA value does not comprise a serving link TA value, or the first TA value is not determined based on the serving link TA value; and
the first TA value comprises a feeder link TA value, or the first TA value is determined based on the feeder link TA value.

17. The terminal device according to claim 15, wherein the first TA value comprises a public serving link TA value, or the first TA value is determined based on the public serving link TA value; wherein the public serving link TA value satisfies at least one of:
the public serving link TA value being configured;
the public serving link TA value being predefined;
the public serving link TA value being a serving link TA value of the terminal device at a first instant;
the public serving link TA value being a serving link TA value corresponding to a first reference position; or
the public serving link TA value being a serving link TA value corresponding to the first reference position and the first instant.

18. The terminal device according to claim 15, wherein the first TA value corresponds to the first instant; and the first instant satisfies at least one of:
the first instant being configured;
the first instant corresponding to a first uplink positioning signal resource in the M uplink positioning signal resources; or
the first instant corresponding to a transmit instant of the first uplink positioning signal resource in the M uplink positioning signal resources.

19. A network device, comprising:
a processor;
a transceiver connected to the processor; and
a memory configured to store one or more instructions executable by the processor;
wherein the processor, when loading and executing the one or more executable instructions, is caused to perform the wireless communication method for positioning as defined in claim 11.

20. A chip, comprising at least one programmable logic circuit and/or at least one program, wherein a communication device equipped with the chip, when running, is caused to perform the wireless communication method for positioning as defined in claim 1.
